(19) United States
(12) Patent Application Publication
(10) Pub. No.: US 2007/0126847 A1
(43) Pub. Date: Jun. 7, 2007

(54) Thermal recording method and apparatus

(75) Inventor: Masakazu Fukuyo, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/633,427

(22) Filed: Dec. 5, 2006

(30) Foreign Application Priority Data
Dec. 5, 2005 (JP) 2005-350285

(51) Int. Cl. B41J 2/00

(52) U.S. Cl. 347/193

(57) ABSTRACT

The thermal recording method and apparatus perform image recording on a recording medium line by line at a predetermined recording speed, or predetermined recording times, amplitudes or numbers corresponding to predetermined recording densities by means of a thermal head while the recording medium is transported at a predetermined transport speed in a direction perpendicular to a direction in which recording elements of the thermal head are arranged, with the thermal head being pressed against the recording medium, analyze densities of an image to be recorded and adjust the predetermined recording speed, or the predetermined recording times, amplitudes or numbers for recording the image line by line by means of the thermal head based on an analyzing result of the densities of the image to be recorded.

### BACKGROUND OF THE INVENTION

The present invention relates to a method and an apparatus for thermal recording in which the thermal recording is performed on a thermal recording material with a thermal head. More specifically, the present invention relates to a method and an apparatus for thermal recording that are used to suppress an influence of density unevenness caused by the density profile depending on a pattern of an image to be recorded.

A thermal recording apparatus that uses a thermal recording material having a thermal recording layer formed on one side of a support made of, for example, a film or paper (hereinafter referred to simply as “thermal material”) has been conventionally employed to record images for ultrasonic diagnosis. The thermal recording apparatus eliminates the need for wet processing and offers several advantages including convenience in handling. Hence in recent years, the use of the thermal recording apparatus is not limited to small-scale applications such as ultrasonic diagnosis and an extension to those areas of medical diagnoses such as CT (Computerized Tomography), MRI (Magnetic Resonance Imaging) and X-ray photography where large and high-quality images are required is under review.

The thermal recording apparatus uses a thermal head having a glaze in which heat generating resistors are arranged in one direction to thereby record an image while heating the thermal recording layer of a thermal material. More specifically, in the thermal recording apparatus in which a platen roller presses a thermal material against the thermal head, the platen roller is rotated to move a glaze (heat generating resistors) and the thermal material (thermal recording layer) relative to each other in a direction perpendicular to a direction in which the glaze extends, with the glaze slightly pressed against the thermal material, and energy is applied to each of the heat generating resistors to heat the thermal recording layer of the thermal material imagewise in accordance with an image to be recorded, whereby image recording is performed.

A material that has a thermal recording layer formed on one surface of a support made of a film such as a transparent polyethylene terephthalate (PET) film or paper has been conventionally used in the thermal recording apparatus as a thermal material for recording, for example, images for medical diagnosis. In the case where the above-mentioned thermal recording is performed with such a thermal material, the surface of the thermal material heated during the image recording melts.

Melting of the thermal material that may be caused by the image recording with the thermal recording apparatus does not necessarily take place constantly but varies with the temperature of the thermal head that depends on the image density.

An example is shown in FIG. 3, in which a thermal material 100 is transported at a constant speed in a transport direction D in the case where a pattern image 102 is to be recorded on the thermal material 100. The pattern image 102 has a frame 104 (shaded portion) and an opening 106 having a rectangular shape as a whole. The frame 104 is black, whereas the opening 106 is white. The frame 104 is higher in density than the opening 106, so there is a large density difference between the frame 104 and the opening 106.

In the case where the pattern image 102 is recorded on the thermal material 100, the thermal head is pressed against the thermal material during the transport of the thermal material 100 so that the respective heat generating resistors are driven for an energizing time determined in accordance with image data to record the image line by line in a recording direction R (i.e., from a line d₁, to a line d₄).

An area between the line d₁ and a line d₂ is a high-density line area in which a large number of black pixels are present. An arena between the line d₂ and a line d₃ is a low-density line area in which a large number of white pixels are present. An area between the line d₃ and the line d₄ is a high-density line area.

FIG. 4A is a graph showing an image density profile along a line X₁-X₁ shown in FIG. 3, in which the axis of ordinates represents image density and the axis of abscissas represents image position. FIG. 4B is a graph showing an image density profile along a line X₂-X₂ shown in FIG. 3, in which the axis of ordinates represents image density and the axis of abscissas represents image position.

FIG. 4A faithfully reproduces image densities in the line X₁-X₁ shown in FIG. 3. In FIG. 4A, a higher density portion corresponds to the frame 104, and a lower density portion corresponds to the opening 106.

On the other hand, as shown in FIG. 4B, although the X₂-X₂ line should essentially have an even density profile, a region a near the line d₂ has higher densities than the actual densities, thus causing linear density unevenness. A region β near the line d₃ has lower densities than the actual densities, thus also causing linear density unevenness.

The linear density unevenness shown in FIG. 4B is due to frictional resistance between the thermal head and a thermal recording sheet. In other words, although a protective layer made of a resin is formed on a surface of the thermal recording sheet, the coefficient of friction of the protective layer with respect to the thermal head varies with the average temperature of the thermal head. To be more specific, transfer from the high-density line area having a large number of pixels to the low-density line area having a large number of white pixels causes the average temperature of the thermal head to be decreased, which results in an abrupt increase of the coefficient of friction. Thus, the pitch at which the thermal recording sheet is transported is temporarily decreased to cause linear density unevenness in the transfer portion where the density is higher than the peripheral portions.

On the other hand, transfer from the low-density line area having a large number of white pixels to the high-density line area having a large number of white pixels causes the transport pitch of the thermal recording sheet to be temporarily increased due to an abrupt decrease of the coefficient of friction, leading to linear density unevenness in the transfer portion where the density is lower than the peripheral portions. The density unevenness is known to take place in a portion having large image density fluctuations. Accordingly, various thermal recording apparatuses (i.e., thermal printers) capable of suppressing occurrence of the density unevenness have been proposed (see JP 2002-067370 A).

In a thermal printer disclosed in JP 2002-067370 A, a frictional load on the thermal head is calculated for each line, and the amount of load variation is determined from the difference between the frictional load of the current line and that of the former line. Then, printing energy obtained from the image data is converted into a value smaller than the normal value to suppress an abrupt density increase when the thermal head transfers from the high-density line area to the low-density line area, thus preventing the transfer portion from having higher densities than the peripheral portions to cause linear density unevenness. On the other hand, the printing energy is converted into a value larger than the normal value to suppress an abrupt density decrease when the thermal head transfers from the low-density line area to the high-density line area, thus preventing the transfer portion from having lower densities than the peripheral portions to cause linear density unevenness.

### SUMMARY OF THE INVENTION

However, JP 2002-067370 A has a problem in that suppression of the density unevenness based on the difference between the length of the sheet transported and the recording length of the sheet is not satisfactorily achieved in the case where an image to be recorded has large density fluctuations, although the printing energy itself is adjusted to prevent occurrence of the density unevenness.

In order to solve the above-mentioned conventional problem, an object of the present invention is to provide a thermal recording method that is capable of suppressing an influence of density unevenness caused by the density profile of an image to be recorded, and in particular sufficiently suppressing occurrence of density unevenness even in the case where the image to be recorded has large density fluctuations, whereby high-quality images can be recorded.

Another object of the present invention is to provide a thermal recording apparatus for implementing the thermal recording method described above.

In order to achieve the above objects, a first aspect of the present invention provides a thermal recording method, comprising:

a step of performing image recording on a recording medium line by line at a predetermined recording speed by means of a thermal head while the recording medium is transported at a predetermined transport speed in a direction perpendicular to a direction in which recording elements of the thermal head are arranged, with the thermal head being pressed against the recording medium;

a step of analyzing densities of an image to be recorded; and

a step of adjusting the predetermined recording speed for recording the image line by line by means of the thermal head based on an analyzing result of the densities of the image to be recorded.

In a preferred embodiment of the present invention, the adjusting step of adjusting the predetermined recording speed for recording the image compares image densities of at least successive two lines to each other, and when a density difference between the image densities of successive two lines exceeds a predetermined value and a first line to be first recorded is higher in density than a second line to be subsequently recorded, the adjusting step sets a recording speed for the second line to be subsequently recorded to be lower than the predetermined recording speed for the second line and when the density difference between the image densities of the successive two lines exceeds the predetermined value and the first line to be first recorded is lower in density than the second line to be subsequently recorded, the adjusting step sets a recording speed for the second line to be subsequently recorded to be higher than the predetermined recording speed for the second line.

A second aspect of the present invention provides a thermal recording method, comprising:

a step of performing image recording on a recording medium line by line at predetermined recording times, predetermined recording amplitudes or predetermined recording numbers corresponding to predetermined recording densities by means of a thermal head while the recording medium is transported at a predetermined transport speed in a direction perpendicular to a direction in which recording elements of the thermal head are arranged, with the thermal head being pressed against the recording medium;

a step of analyzing densities of an image to be recorded; and

a step of adjusting the predetermined recording times, the predetermined recording amplitudes or the predetermined recording numbers corresponding to the predetermined recording densities for recording the image line by line by means of the thermal head based on an analyzing result of the densities of the image to be recorded.

In a preferred embodiment of the present invention, the adjusting step of adjusting the predetermined recording times, the predetermined recording amplitudes or the predetermined recording numbers corresponding to the predetermined recording densities for recording the image compares image densities of at least successive two lines to each other, and when a density difference between the image densities of successive two lines exceeds a predetermined value and a first line to be first recorded is higher in density than a second line to be subsequently recorded, the adjusting step sets recording times, recording amplitudes or recording numbers for the second line to be subsequently recorded to be shorter, smaller or fewer than the predetermined recording times, the predetermined recording amplitudes or the predetermined recording numbers for the second line and when the density difference between the image densities of the successive two lines exceeds the predetermined value and the first line to be first recorded is lower in density than the second line to be subsequently recorded, the adjusting step sets recording times, recording amplitudes or recording numbers for the second line to be subsequently recorded to be longer, larger or more than the predetermined recording times, the predetermined recording amplitudes or the predetermined recording numbers for the second line, respectively.

A third aspect of the present invention provides a thermal recording apparatus, comprising:

a thermal head having recording elements arranged in a first direction, the thermal head performing image recording on a recording medium line by line at a predetermined recording speed;

transport means for transporting the recording medium at a predetermined transport speed in a second direction perpendicular to the first direction during the image recording;

pressing means for pressing the thermal head against the recording medium during the image recording; and

a control unit that analyzes densities of an image to be recorded and adjusts the predetermined recording speed for recording the image line by line by means of the thermal head based on an analyzing result of the densities of the image to be recorded.

In a preferred embodiment of the present invention, the control unit compares image densities of at least successive two lines to each other, and when a density difference between the image densities of successive two lines exceeds a predetermined value and a first line to be first recorded is higher in density than a second line to be subsequently recorded, the control unit sets a recording speed for the second line to be subsequently recorded to be lower than the predetermined recording speed for the second line and when the density difference between the image densities of the successive two lines exceeds the predetermined value and the first line to be first recorded is lower in density than the second line to be subsequently recorded, the control unit sets a recording speed for the second line to be subsequently recorded to be higher than the predetermined recording speed for the second line.

A fourth aspect of the present invention provides a thermal recording apparatus, comprising:

a thermal head having recording elements arranged in a first direction, the thermal head performing image recording on a recording medium line by line at predetermined recording times, predetermined recording amplitudes or predetermined recording numbers corresponding to predetermined recording densities;

transport means for transporting the recording medium at a predetermined transport speed in a second direction perpendicular to the first direction during the image recording;

pressing means for pressing the thermal head against the recording medium during the image recording; and

a control unit which analyzes densities of an image to be recorded and adjusts the predetermined recording times, the predetermined recording amplitudes or the predetermined recording numbers corresponding to predetermined recording densities for recording the image line by line by means of the thermal head based on an analyzing result of the densities of the image to be recorded.

In a preferred embodiment of the present invention, the control unit compares image densities of at least successive two lines to each other, and when a density difference between the image densities of successive two lines exceeds a predetermined value and a first line to be first recorded is higher in density than a second line to be subsequently recorded, the control unit sets recording times, recording amplitudes or recording numbers for the second line to be subsequently recorded to be shorter, smaller or fewer than the predetermined recording times, the predetermined recording amplitudes or the predetermined recording numbers for the second line and when the density difference between the image densities of the successive two lines exceeds the predetermined value and the first line to be first recorded is lower in density than the second line to be subsequently recorded, the control unit sets recording times, recording amplitudes or recording numbers for the second line to be subsequently recorded to be longer, larger or more than the predetermined recording times, the predetermined recording amplitudes or the predetermined recording numbers for the second line, respectively.

The thermal recording method in the first aspect of the present invention which includes the step of analyzing densities of an image to be recorded and a step of adjusting a recording speed for recording the image line by line based on the densities of the image to be recorded, can reduce the difference between the transport length and the recording length and hence influences of the fluctuations of the transport length of a thermal material that may be caused by fluctuations of the amount of melting on the surface of the thermal material during image recording attributable to the density profile of the image to be recorded can be suppressed to enable accurate image recording. Therefore, influences of density unevenness due to the density profile of the image to be recorded can be suppressed, and in particular, even in the case where the image to be recorded has large density fluctuations, occurrence of density unevenness can be fully suppressed to enable recording of a high-quality image.

The thermal recording method in the second aspect of the present invention which includes the step of analyzing densities of an image to be recorded and the step of adjusting a recording time for recording the image line by line based on the densities of the image to be recorded, can reduce the difference between the transport length and the recording length and hence influences of the fluctuations of the transport length of a thermal material that may be caused by fluctuations of the amount of melting on the surface of the thermal material during image recording attributable to the density profile of the image to be recorded can be suppressed to enable accurate image recording. Therefore, influences of density unevenness due to the density profile of the image to be recorded can be suppressed, and in particular, even in the case where the image to be recorded has large density fluctuations, occurrence of density unevenness can be fully suppressed to enable recording of a high-quality image.

The thermal recording apparatus in the third aspect of the present invention including a control unit which analyzes densities of an image to be recorded and adjusts a recording speed for recording the image line by line based on the densities of the image to be recorded, can reduce the difference between the transport length and the recording length and hence influences of the fluctuations of the transport length of a thermal material that may be caused by fluctuations of the amount of melting on the surface of the thermal material during image recording attributable to the density profile of the image to be recorded can be suppressed to enable accurate image recording. Therefore, influences of density unevenness due to the density profile of the image to be recorded can be suppressed, and in particular, even in the case where the image to be recorded has large density fluctuations, occurrence of density unevenness can be fully suppressed to enable recording of a high-quality image.

The thermal recording apparatus in the fourth aspect of the present invention including a control unit which analyzes densities of an image to be recorded and adjusts a recording time for recording the image line by line based on the densities of the image to be recorded, can reduce the difference between the transport length and the recording length and hence influences of the fluctuations of the transport length of a thermal material that may be caused by fluctuations of the amount of melting on the surface of the thermal material during image recording attributable to the density profile of the image to be recorded can be suppressed to enable accurate image recording. Therefore, influences of density unevenness due to the density profile of the image to be recorded can be suppressed, and in particular, even in the case where the image to be recorded has large density fluctuations, occurrence of density unevenness can be fully suppressed to enable recording of a high-quality image.

### BRIEF DESCRIPTION OF THE DRAWINGS

In the accompanying drawings:

FIG. 1 is a schematic sectional view showing an embodiment of a thermal recording apparatus of the present invention;

FIG. 2 is a schematic view showing a recording section of the thermal recording apparatus of the present invention;

FIG. 3 schematically shows a pattern image to be recorded on a thermal material;

FIG. 4A is a graph showing an image density profile along a line X₁-X₁ shown in FIG. 3 in which the axis of ordinates represents image density and the axis of abscissas represents image position; and

FIG. 4B is a graph showing an image density profile along a line X₂-X₂ shown in FIG. 3 in which the axis of ordinates represents image density and the axis of abscissas represents image position.

### DESCRIPTION OF THE PREFERRED EMBODIMENTS

The thermal recording method and apparatus of the present invention will be described below in detail based on preferred embodiments shown in the accompanying drawings.

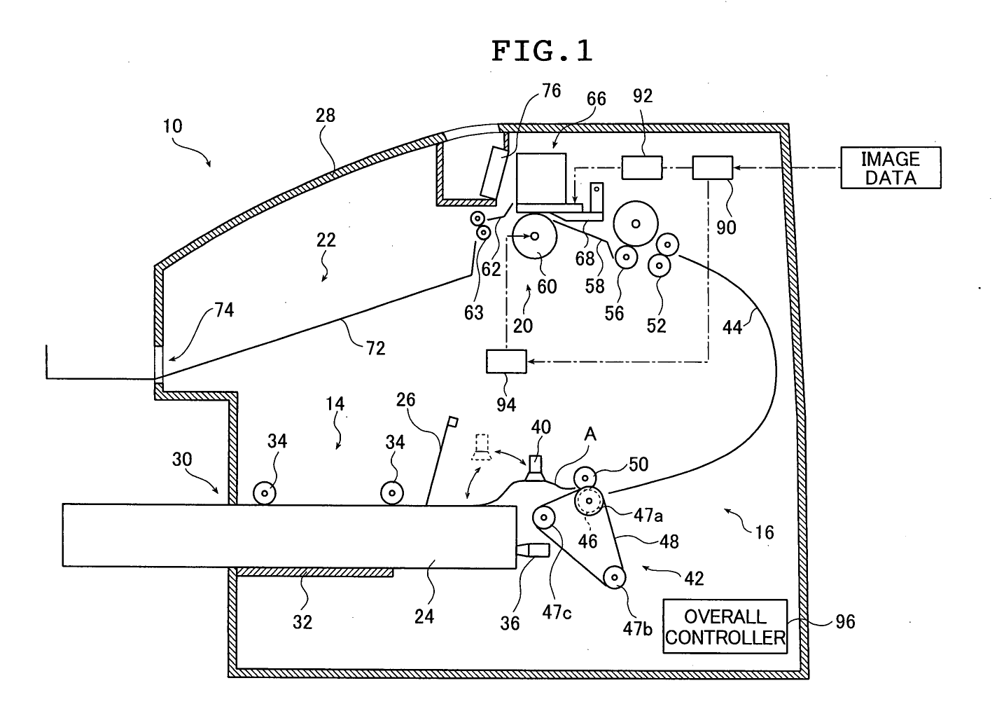

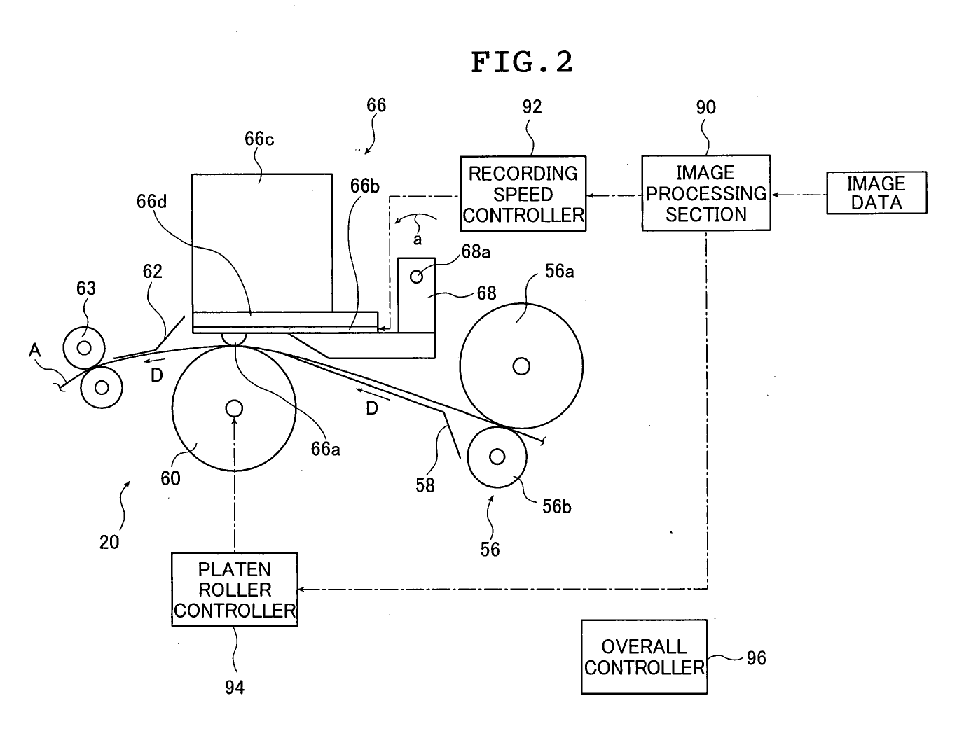

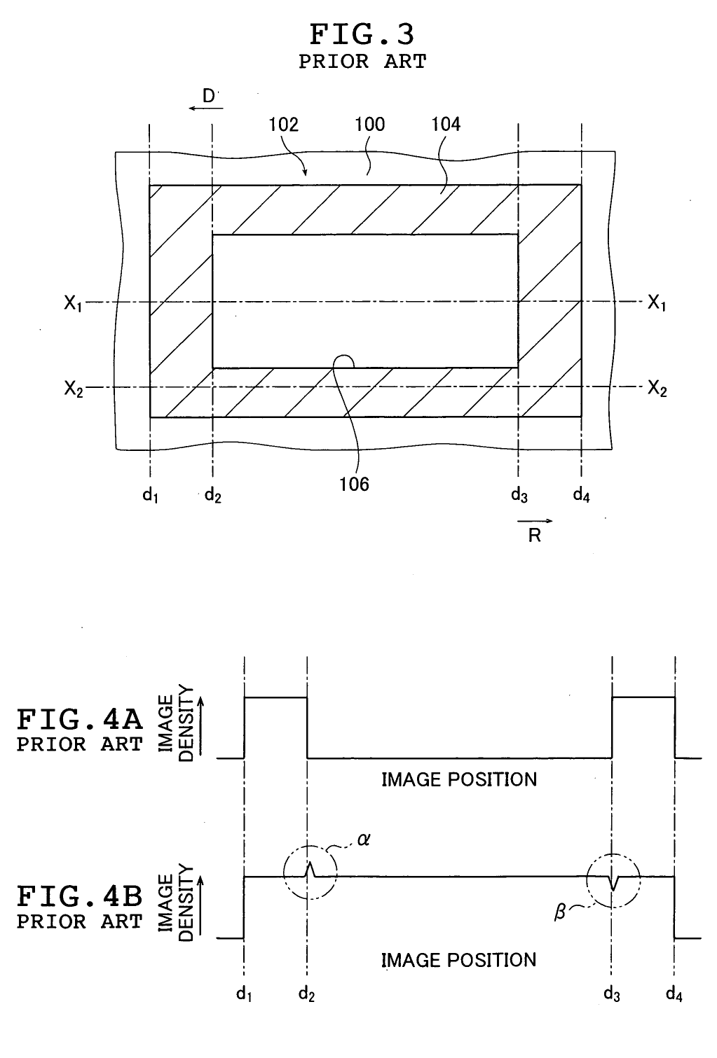

FIG. 1 is a schematic sectional view showing an embodiment of a thermal recording apparatus of the present invention. FIG. 2 is a schematic view showing a recording section of the thermal recording apparatus of the present invention.

In a thermal recording apparatus (hereinafter referred to as a “recording apparatus”) 10 shown in FIG. 1, thermal recording is performed on a thermal material A cut into sheets of a predetermined size such as B4 size. The recording apparatus 10 includes a loading section 14 into which a magazine 24 containing the thermal material A is loaded, a supply/transport section 16, a recording section 20 in which a thermal head 66 performs thermal recording on the thermal material A and a discharge section 22.

The recording apparatus 10 also includes a control system having an image processing section 90, a recording speed controller 92, a platen roller controller 94 and an overall controller 96. The recording speed controller 92, the platen roller controller 94 and the overall controller 96 constitute the control unit of the present invention.

The recording apparatus 10 performs thermal recording on the thermal material A by heating individual heating (recording) elements of the thermal head 66 in accordance with an image to be recorded while the thermal material A transported to the recording section 20 by the supply/transport section 16 is transported in a longitudinal direction of a glaze 66a of the thermal head 66 (in a direction in which the recording elements of the thermal head 66 are arranged), with the glaze 66a of the thermal head 66 pressed against the thermal material A.

The thermal material A is obtained by forming a thermal recording layer on the entire surface of a support made of a film such as a transparent polyethylene terephthalate (PET) film or paper. Typically, such thermal sheets A are stacked in a specified number, say, 100 to form a bundle, which is either wrapped in a bag or bound with a band to provide a package. In this embodiment, the thermal sheets stacked in the specified number are accommodated in the magazine 24 of the recording apparatus 10 with their thermal recording layer facing down, and taken out of the magazine 24 one by one to be used for thermal recording.

The magazine 24 is a case having a cover 26 which can be freely opened, and the magazine 24 accommodating the thermal material A is loaded into the loading section 14 of the recording apparatus 10. The loading section 14 has an inlet 30 formed in a housing 28 of the recording apparatus 10, a guide plate 32, guide rolls 34 and a stop member 36. The magazine is inserted into the recording apparatus 10 via the inlet 30 in such a way that the portion fitted with the cover 26 is coming first; thereafter, the magazine 24 as it is guided by the guide plate 32 and guide rolls 34 is pushed until it contacts the stop member 36, whereupon it is loaded at a specified position in the recording apparatus 10.

The feed/transport section 16 has a sheet feeding mechanism using a suction cup 40 for grabbing the thermal material A by application of suction, transport means 42, a transport guide 44 and a regulating roller pair 52 located in the outlet of the transport guide 44; the thermal material A is taken out of the magazine 24 in the loading section 14 and transported to the recording section 20.

The transport means 42 includes a transport roller 46, a pulley 47a coaxial with the roller 46, a pulley 47b coupled to a rotating drive source, a tension pulley 47c, an endless belt 48 stretched around the three pulleys 47a, 47b and 47c, and a nip roller 50 that is to be pressed onto the transport roller 46. One sheet of thermal material A is picked up by the suction cup 40 and is transported with its forward end nipped between the transport roller 46 and the nip roller 50.

The distance between the transport means 42 and the regulating roller pair 52 which is defined by the transport guide 44 is set to be somewhat shorter than the length of the thermal material A in the direction of its transport.

As shown in FIG. 2, the recording section 20 has the thermal head 66, a platen roller 60, a cleaning roller pair 56, a guide 58, a fan 76 for cooling the thermal head 66 (see FIG. 1) and a guide 62.

The thermal head 66 shown in FIG. 2 is capable of thermal recording at a recording (pixel) density of, say, about 300 dpi on the thermal material of up to, for example, B4 size. The head includes a ceramic substrate 66b that has the glaze 66a in which a large number of heat generating resistors (Not shown) serving as heating elements performing thermal recording on the thermal material A are arranged in one direction (longitudinal direction perpendicular to the paper of FIGS. 1 and 2) and is made of an electrical insulating material having excellent heat resistance (e.g., alumina ceramic), a base plate 66d that is made of a metal such as aluminum and is formed on the opposite side of the ceramic substrate 66b from the glaze 66a, and a heat sink 66c that is fixed to the opposite side of the base plate 66d from the ceramic substrate 66b, is made of a metal such as aluminum and has a large number of radiation fins (not shown). The thermal head 66 is supported on a support member 68 that can pivot about a fulcrum 68a either in the direction of arrow a or in the reverse direction.

The platen roller 60 rotates while regulating the thermal material A at a specified position, and transports the thermal material A in a direction (transport direction of arrow D in FIG. 2) perpendicular to a main scanning direction. The recording speed controller 92 determines the transport speed. The platen roller controller 94 controls the drive of the platen roller 60.

The cleaning roller pair 56 includes a sticky rubber roller 56a made of an elastic material and a non-sticky roller 56b. The sticky rubber roller 56a removes dust having adhered to the thermal recording layer of the thermal material A to prevent the dust from adhering to the glaze 66a to adversely affect image recording.

The discharge section 22 includes the guide 62, a transport roller pair 63, a tray 72, and an outlet 74 formed in the housing. After the end of thermal recording, the thermal material A as it is guided by the guide 62 is transported through the transport roller pair 63 to the tray 72 and is discharged through the outlet 74 from the recording apparatus 10.

Next, the control system of the recording apparatus 10 shown in FIG. 1 will be described. As described above, the recording apparatus 10 includes, as the control system, the image processing section 90, the recording speed controller 92, the platen roller controller 94, and the overall controller 96.

The image processing section 90 receives image data of an image to be recorded and subjects the received image data to predetermined image processing steps such as sharpness correction (i.e., sharpness enhancement), gradation correction, temperature correction, shading correction and black ratio correction and optionally formatting (scaling up/down and frame allocation) to obtain outputting image data (image data for forming an image on the thermal material A). The outputting image data is converted into a driving signal of the thermal head 66, which is then outputted to the recording speed controller 92. The recording speed controller 92 drives the thermal head 66 (more specifically respective heating elements of the glaze 66a of the ceramic substrate 66b thereof). The outputting image data generated in the image processing section 90 is also outputted to the platen roller controller 94.

The recording speed controller 92 calculates the image densities based on the outputting image data transmitted from the image processing section 90, and compares the density of the current recording line and that of the subsequent recording line to estimate the fluctuation of the transport speed. Then, the recording speed controller 92 extracts the recording line in which the transport speed is inconsistent with the recording speed (hereinafter referred to as “inconsistent recording line”), and adjusts the recording speed (speed for recording one line by driving respective heating elements of the glaze 66a of the thermal head 66) in the inconsistent recording line so as to obtain an appropriate image. In this embodiment, the recording speed is adjusted by changing the recording frequency (for example, the clock frequency of the driving signal of the thermal head 66).

In this embodiment, recording frequencies for suppressing the inconsistency that may occur between the transport length and the recording length when the difference between the densities of at least successive two lines adjacent to each other in the transport direction D is larger than the difference between the predetermined values, are prepared in advance experimentally or by a simulation or other operation, for each density difference and each line density value. The recording speed controller 92A includes a storage unit (not shown) having the respective recording frequencies stored therein. In this case, an arithmetic expression for obtaining the most appropriate recording frequency may be used by setting the density difference and the densities of the respective lines as parameters.

The platen roller controller 94 determines from the outputting image data, the speed of the thermal material A transported by the platen roller 60 in the subsequent thermal recording (i.e., image recording based on the outputting image data which has been currently inputted). Then, the platen roller controller 94 sets the rotational speed of the platen roller 60 and drives a motor (not shown) serving as a rotation drive source of the platen roller 60 at the set rotational speed so that the thermal material A is transported at the set transport speed. The rotational speed of the platen roller 60 (i.e., transport speed of the thermal material A) is set (or adjusted) based on the setting of the drive pulse of the motor or the clock frequency.

The overall controller 96 is connected to the loading section 14, the supply/transport section 16, the recording section 20 for performing thermal recording on the thermal material A with the thermal head 66, the discharge section 22, and the image processing section 90 which constitute the recording apparatus 10, as well as the recording speed controller 92 and the platen roller controller 94 of the control system. The overall controller 96 grasps the operating conditions thereof and controls the overall operations of the recording apparatus 10 such as operation timings thereof.

The overall controller 96 synchronizes the start timing of image recording as controlled by the recording speed controller 92 with the timing for starting the transport of the thermal material A as controlled by the platen roller controller 94.

As described above, when the thermal head 66 (glaze 66a) is pressed onto the surface of the thermal material A to heat the thermal material A for thermal recording, the surface of the heated thermal material A is melted. The degree of melting on the surface of the thermal material A (i.e., the amount of the melted thermal material) varies with the amount of heat the thermal material A has during thermal recording.

The recording apparatus 10 of this embodiment adjusts the inconsistency between the transport speed and the recording speed taking into account the fluctuations of the transport speed caused by the fluctuations of the transport length of the thermal material A as described above when the thermal material A is transported at a predetermined (constant) speed, thereby allowing accurate images to be thermally recorded in a consistent manner. Thus, the outputting image data is analyzed for the density and density differences between at least two image recording lines are compared with each other. The recording speed for recording a pixel of interest is adjusted by, for example, the recording frequency (or recording timing of the respective lines) for a recording line in which the density difference is larger than the predetermined value and fluctuations of the transport speed is expected. Thermal recording is thus performed.

As a higher-density image is recorded, thermal recording requires a larger amount of heat. Therefore, the higher the recording density is, the larger the amount of heat on the thermal material A is. Thus, the amount of the melted thermal material A is increased. In other words, a higher recording density results in increases of the sliding length during the transport of the thermal material A, the transport length of the thermal material A and the recording length on the thermal material A. On the contrary, a lower image density requires less amount of heat for recording. In other words, the low-density recording results in a reduced recording length on the thermal material A unlike the high-density recording.

Therefore, the recording frequency (i.e., recording timing) can be adjusted in accordance with the densities of an image to be recorded to thereby suppress an influence of density unevenness caused by the inconsistency between the transport speed and the recording speed.

In this embodiment, density analysis of the recording image, that is, the outputting image data is performed to detect the densities of the recording pixels, which are then used as one of the parameters for adjusting the recording speed.

In this embodiment, the recording speed controller 92 calculates the image densities based on the outputting image data transmitted from the image processing section 90, and compares the density of the current recording line (first recording line) with the density of the subsequent recording line (second recording line) to estimate the fluctuation of the transport speed. When the current recording line is high in density whereas the subsequent recording line is low in density, the transport length in the current recording line is increased as described above, and if the subsequent recording line is recorded as it is at the predetermined recording speed (i.e., recording timing) based on the value of the outputting image data, the recording regions of the current line and the subsequent line overlap each other, which generates a high-density region. Thus, the recording speed in such a inconsistent recording line is set to be lower than the predetermined recording speed (recording timing) based on the value of the outputting image data. In other words, the recording timing is delayed. The recording timing is delayed by, for example, lowering the recording frequency. In this case, the recording frequency is lowered by an amount determined by referring to the above-mentioned storage unit.

On the other hand, when the current recording line is low in density whereas the subsequent recording line is high in density, the transport length in the current recording line is reduced as described above, and if the subsequent recording line is recorded as it is at the predetermined recording speed (i.e., recording timing) based on the value of the outputting image data, a region in which no image is recorded is formed between the current line and the subsequent line, thus producing a low-density region. The recording speed in such a inconsistent recording line is set to be higher than the predetermined recording speed (recording timing) based on the value of the outputting image data. In other words, the recording timing is advanced. The recording timing is advanced by, for example, increasing the recording frequency. In this case, the recording frequency is increased by an amount determined by referring to the above-mentioned storage unit.

In the present invention, the delay or advance of the recording timing, that is, the setting of the recording frequency may be adjusted at more than one level based on the density difference between the current recording line and the subsequent recording line, and the density of the current recording line and that of the subsequent recording line. It is also possible to set an arithmetic expression for the delay or advance of the recording timing based on the density difference between the current recording line and the subsequent recording line and to determine the value of the recording timing to be delayed or advanced, that is, the value of the recording frequency from the arithmetic expression.

It is to be understood that, in the case where there is no need to delay or advance the recording timing as a result of the image densities calculated from the outputting image data, recording is performed in the present invention at the recording frequency (recording timing) set in advance according to the predetermined transport speed.

The platen roller 60 is driven by the motor serving as the drive source of the platen roller 60 so that the rotational speed of the platen roller 60 coincides with the set constant transport speed.

Further, in this embodiment, to what degree the recording frequency (recording timing) is delayed or advanced may be determined taking the type of the thermal material A into consideration, because the degree of melting caused by heating and also the thickness of the thermal material A vary with the type of the thermal material A, and the fluctuations of the recording length attributable to the fluctuations of the amount of melting may also vary even at the same transport speed. By taking the type of the thermal material A into consideration to determine to what degree the recording frequency is delayed or advanced, the difference between the transport length and the recording length can be reduced more consistently to achieve recording on the exact recording length.

Hereinafter, the operation of the recording apparatus 10 will be described in detail.

In the recording apparatus 10, the image processing section 90 to which the image data has been inputted performs various kinds of processing on the inputted image data to produce the outputting image data, which is then outputted to the recording speed controller 92 and the platen roller controller 94.

The recording speed controller 92 calculates the image densities from the outputting image data, and compares the density of each recording line and that of the recording line which is to be subsequently recorded, thereby determining for each recording line that is high in density and requires adjusting the recording speed, to what degree the recording timing is delayed or advanced.

On the other hand, the platen roller controller 94 sets the predetermined transport speed based on the outputting image data and controls the rotational speed of the motor so as to transport the thermal material A at the set transport speed.

Next, when a command for RECORDING START is issued, the cover 26 is opened by an open/close mechanism (not shown) in parallel with a step of calculation for delaying or advancing the recording timing (i.e., a step of calculating the recording frequency value), so that a sheet feeding mechanism using the suction cup 40 takes one sheet of thermal material A out of the magazine 24, and supplies its leading edge to the transport means 42 (more specifically, the transport roller 46 and the nip roller 50). At the point of time when the thermal material A is nipped between the transport roller 46 and the nip roller 50, the suction force from the suction cup 40 is released, and the supplied thermal material A is transported to the regulating roller pair 52 by the transport means 42 while being guided by the transport guide 44.

The open/close mechanism closes the cover 26 at the point of time when the thermal material A to be used for recording has been completely discharged from the magazine 24.

The leading edge of the thermal material A is transported by the transport means 42 to reach the regulating roller pair 52, which is first at rest. The leading edge of the thermal material A is temporarily stopped at the regulating roller pair 52 for positioning.

At the point of time when the leading edge of the thermal material A has reached the regulating roller pair 52, the temperature of the thermal head 66 (more specifically the glaze 66a) is checked. When the thermal head 66 has the predetermined temperature, the platen roller controller 94 sets the rotational speed of the platen roller 60 according to the predetermined transport speed, and drives the motor (not shown) serving as the rotation drive source of the platen roller 60 at the set rotational speed.

The regulating roller pair 52A starts transport of the thermal material A, which is transported to the recording section 20. In the illustrated recording apparatus 10, before the thermal material A is transported to the recording section 20, the support member 68 rotates upward (i.e., in a direction opposite to the direction indicated by an arrow a), and is not brought into contact with the thermal head 66 (more specifically the glaze 66a) and the platen roller 60.

When the regulating roller pair 52 starts transporting the thermal material A, the thermal material A is subsequently nipped by the cleaning roller pair 56, and is further transported while being guided by the guide 58. When the leading edge of the thermal material A is transported to the recording start position (i.e., position corresponding to the glaze 66a), the support member 68 rotates in the direction indicated by the arrow a, and the thermal material A is nipped between the glaze 66a of the thermal head 66 and the platen roller 60. Thus, the glaze 66a is pressed against the recording layer of the thermal material A. The thermal material A is transported in the transport direction D by the platen roller 60 (and the regulating roller pair 52 and the transport roller pair 63) while being regulated at the predetermined position by the platen roller 60.

While the thermal material A is thus being transported, the respective heat generating resistors of the glaze 66a are heated in accordance with the recording image data to thereby perform thermal recording on the thermal material A.

In this process, the recording speed controller 92 performs density analysis of the outputting image data. In the density analysis, the densities of at least successive two lines are compared to each other and the inconsistent recording line is extracted in which it is estimated that the density difference is larger than the predetermined value to cause inconsistency between the transport speed and the recording speed and hence density unevenness, leading to incapability of accurate image recording. The recording frequency in the inconsistent recording line is changed based on the magnitude correlation between the densities of the successive two lines, and the recording timing (recording speed) is appropriately adjusted to make the transport speed and the recording speed consistent with each other. As a result, image recording can be performed with accuracy. Thus, a high-quality image can be obtained in a consistent manner while suppressing occurrence of density unevenness.

After the end of thermal recording, the thermal material A as it is guided by the guide 62 is transported by the platen roller 60 and the transport roller pair 63 to be discharged into the tray 72 in the discharge section 22. The tray 72 projects exterior to the recording apparatus 10 via the outlet 74 formed in the housing 28 and the thermal material A carrying the recorded image is discharged via the outlet 74 for takeout by an operator.

As described above, according to the thermal recording apparatus of the present invention, the inconsistent recording line is extracted in consideration of the fluctuations of the transport length of the thermal material during image recording, and the image recording timing in the extracted inconsistent recording line is adjusted based on the recording frequency. Thermal recording can be thus performed while making the transport speed consistent with the recording speed, thereby reducing the difference between the transport length and the recording length. In this way, influences of the fluctuations of the transport length of the thermal material that may be caused by fluctuations of the amount of melting on the surface of the thermal material during image recording attributable to the density profile of an image to be recorded can be suppressed to avoid any influence of the density unevenness on the image to be recorded. In particular, even in the case where the image to be recorded has large density fluctuations, occurrence of density unevenness can be fully suppressed to enable recording of a high-quality image.

In this embodiment, the recording speed controller 92 analyzes the densities of the outputting image data, extracts the inconsistent recording line, and adjusts the delay or advance of the recording timing (i.e., value of the recording frequency) in the inconsistent recording line, thereby making the transport speed and the recording speed consistent with each other. However, the present invention is not limited thereto.

For example, the recording speed controller 92 may adjust the density of the pixel to be recorded based on the density difference. In the case of pulse width modulation in which the pixel density is adjusted based on the pulse width (recording time) of the driving signal (driving pulse) for driving each heating element of the thermal head 66 in accordance with the recording density of each pixel of the image, the controller used may have a function of increasing or decreasing the pulse width required for obtaining the density in the outputting image data of a pixel to be recorded, based on the density to be increased or decreased based on the density of the pixel to be adjusted and the density difference.

Also in this case, the pulse width for suppressing the inconsistency between the transport length and the recording length that may occur when the difference between the densities of at least successive two lines is larger than the predetermined difference, is prepared in advance experimentally or by a simulation or other operation. The recording speed controller 92 includes a storage unit (not shown) having the pulse widths recorded for the respective density differences and line density values.

An arithmetic expression for calculating the most appropriate pulse width may be used by setting the density difference and the densities of the respective lines as parameters. Further, increase or decrease of the pulse width may be determined according to the type of the thermal material A. This is because, the degree of melting caused by heating and the thickness of the thermal material A vary with the type of the thermal material A, which may often cause the fluctuations of the recording length attributable to the fluctuations of the amount of melting to differ even when the transport speed is the same. Thus, by taking the type of the thermal material A into consideration, the difference between the transport length and the recording length can be reduced more consistently to achieve recording on the exact recording length.

The recording speed controller 92 calculates the image densities from the outputting image data transmitted from the image processing section 90, and compares the density of the current recording line with the density of the subsequent recording line, to thereby estimate the fluctuations of the transport speed. When the current recording line is high in density whereas the subsequent recording line is low in density, the transport length in the current recording line is increased as described above, and if the subsequent recording line is recorded at the normal recording speed, the recording regions of the current line and the subsequent line overlap each other, which generates a high-density region. Therefore, the image densities of the image to be recorded on the subsequent line are made lower than those of the image data. In other words, the pulse width is decreased. In this case, the pulse width is decreased by an amount determined by referring to the above-mentioned storage unit.

On the other hand, when the current recording line is low in density whereas the subsequent recording line is high in density, the transport length in the current recording line is reduced as described above, and if the subsequent recording line is recorded as it is at the normal recording timing, a region in which no image is recorded is formed between the current line and the subsequent line, thus producing a low-density region. Therefore, the image densities of the image to be recorded on the subsequent line are made lower than those of the image data. In other words, the pulse width is increased. In this case, the pulse width is increased by an amount determined by referring to the above-mentioned storage unit.

In the present invention, the pulse width may be increased or decreased at more than one level based on the density difference between the current recording line and the subsequent recording line, and the density of the current recording line and that of the subsequent recording line. It is also possible to set an arithmetic expression for the increase or decrease of the pulse width based on the density difference between the current recording line and the subsequent recording line and to determine the amount of increase or decrease in the pulse width from the arithmetic expression.

It is to be understood that, in the case where there is no need to increase or decrease in the pulse width as a result of the image densities calculated from the outputting image data, recording is performed in the present invention at the pulse width set in advance according to the predetermined transport speed.

The platen roller 60 is driven by the motor serving as the drive source of the platen roller 60 so that the rotational speed of the platen roller 60 coincides with the set constant transport speed.

According to the present invention, the recording speed controller 92 analyzes the image densities of the image to be recorded and increases or decreases the pulse width from the pulse width set for the image densities of the image to be recorded, thereby changing the density of the pixel to be recorded in the inconsistent recording line where density unevenness occurs. The density unevenness that may occur on the image to be recorded can be thus suppressed. The same effect as that in the case of adjusting the recording timing can also be obtained in the case of adjusting the pulse width.

In the case where the pulse width is increased or decreased, the recording speed (recording timing) may be the constant speed corresponding to the speed of the thermal material transported by the platen roller, which eliminates the necessity of the adjustment of the recording speed (recording timing).

In the present invention, the adjustment of the recording frequency (recording timing) and the adjustment of the pulse width may be combined. This combination can also achieve the effect of the present invention. In this case, the above-mentioned recording frequency and pulse width are stored in the storage unit of the recording speed controller 92.

The adjustment of the recording frequency (recording timing) and the adjustment of the pulse width may be simultaneously performed, or may be selectively and appropriately performed in accordance with the magnitude of the density difference. In this case, the combination of the adjustment of the recording frequency (recording timing) and the adjustment of the pulse width which prevents density unevenness more efficiently is determined in advance experimentally or by a simulation or other operation, and the determination results are stored in the storage unit of the recording speed controller 92.

In the above-described case, a typical example in which respective heating elements of the thermal head 66 are driven with the pulse width modulation to record the image is described. However, the present invention is not limited to the typical example. For example, respective heating elements of the thermal head 66 may be driven with the pulse amplitude modulation or the pulse number modulation instead of the pulse width modulation to adjust the pulse amplitude or the pulse number instead of the pulse width. In other word, the pulse amplitude (recording amplitude) may be shorten or lengthen, alternatively, the pulse number (recording number at the predetermined recording amplitude) may be weaken or strengthen instead of decreasing or increasing the pulse width (recording time).

The present invention is basically constituted as described above, but is not limited only to those embodiments. The present invention may be modified or changed without departing from the gist of the present invention.

What is claimed is:

1. A thermal recording method, comprising:
a step of performing image recording on a recording medium line by line at a predetermined recording speed by means of a thermal head while said recording medium is transported at a predetermined transport speed in a direction perpendicular to a direction in which recording elements of said thermal head are arranged, with said thermal head being pressed against said recording medium;
a step of analyzing densities of an image to be recorded; and
a step of adjusting said predetermined recording speed for recording said image line by line by means of said thermal head based on an analyzing result of said densities of said image to be recorded.

2. The thermal recording method according to claim 1, wherein
said adjusting step of adjusting said predetermined recording speed for recording said image compares image densities of at least successive two lines to each other, and
when a density difference between the image densities of successive two lines exceeds a predetermined value and a first line to be first recorded is higher in density than a second line to be subsequently recorded, said adjusting step sets a recording speed for said second line to be subsequently recorded to be lower than said predetermined recording speed for said second line and
when said density difference between the image densities of said successive two lines exceeds said predetermined value and said first line to be first recorded is lower in density than said second line to be subsequently recorded, said adjusting step sets a recording speed for said second line to be subsequently recorded to be higher than said predetermined recording speed for said second line.

3. A thermal recording method, comprising:
a step of performing image recording on a recording medium line by line at predetermined recording times, predetermined recording amplitudes or predetermined recording numbers corresponding to predetermined recording densities by means of a thermal head while said recording medium is transported at a predetermined transport speed in a direction perpendicular to a direction in which recording elements of said thermal head are arranged, with said thermal head being pressed against said recording medium;
a step of analyzing densities of an image to be recorded; and
a step of adjusting said predetermined recording times, said predetermined recording amplitudes or said predetermined recording numbers corresponding to said predetermined recording densities for recording said image line by line by means of said thermal head based on an analyzing result of said densities of said image to be recorded.

4. The thermal recording method according to claim 3, wherein
said adjusting step of adjusting said predetermined recording times, said predetermined recording amplitudes or said predetermined recording numbers corresponding to said predetermined recording densities for recording said image compares image densities of at least successive two lines to each other, and
when a density difference between the image densities of successive two lines exceeds a predetermined value and a first line to be first recorded is higher in density than a second line to be subsequently recorded, said adjusting step sets recording times, recording amplitudes or recording numbers for said second line to be subsequently recorded to be shorter, smaller or fewer than said predetermined recording times, said predetermined recording amplitudes or said predetermined recording numbers for said second line and
when said density difference between the image densities of said successive two lines exceeds said predetermined value and said first line to be first recorded is lower in density than said second line to be subsequently recorded, said adjusting step sets recording times, recording amplitudes or recording numbers for said second line to be subsequently recorded to be longer, larger or more than said predetermined recording times, said predetermined recording amplitudes or said predetermined recording numbers for said second line, respectively.

5. A thermal recording apparatus, comprising:
a thermal head having recording elements arranged in a first direction, said thermal head performing image recording on a recording medium line by line at a predetermined recording speed;
transport means for transporting said recording medium at a predetermined transport speed in a second direction perpendicular to said first direction during the image recording;
pressing means for pressing said thermal head against said recording medium during the image recording; and
a control unit that analyzes densities of an image to be recorded and adjusts said predetermined recording speed for recording said image line by line by means of said thermal head based on an analyzing result of said densities of said image to be recorded.

6. The image recording apparatus according to claim 5, wherein
said control unit compares image densities of at least successive two lines to each other, and
when a density difference between the image densities of successive two lines exceeds a predetermined value and a first line to be first recorded is higher in density than a second line to be subsequently recorded, said control unit sets a recording speed for said second line to be subsequently recorded to be lower than said predetermined recording speed for said second line and
when said density difference between the image densities of said successive two lines exceeds said predetermined value and said first line to be first recorded is lower in density than said second line to be subsequently recorded, said control unit sets a recording speed for said second line to be subsequently recorded to be higher than said predetermined recording speed for said second line.

7. A thermal recording apparatus, comprising:
a thermal head having recording elements arranged in a first direction, said thermal head performing image recording on a recording medium line by line at predetermined recording times, predetermined recording amplitudes or predetermined recording numbers corresponding to predetermined recording densities;
transport means for transporting said recording medium at a predetermined transport speed in a second direction perpendicular to said first direction during the image recording;
pressing means for pressing said thermal head against said recording medium during the image recording; and
a control unit which analyzes densities of an image to be recorded and adjusts said predetermined recording times, said predetermined recording amplitudes or said predetermined recording numbers corresponding to predetermined recording densities for recording said image line by line by means of said thermal head based on an analyzing result of said densities of said image to be recorded.

8. The image recording apparatus according to claim 7, wherein
said control unit compares image densities of at least successive two lines to each other, and
when a density difference between the image densities of successive two lines exceeds a predetermined value and a first line to be first recorded is higher in density than a second line to be subsequently recorded, said control unit sets recording times, recording amplitudes or recording numbers for said second line to be subsequently recorded to be shorter, smaller or fewer than said predetermined recording times, said predetermined recording amplitudes or said predetermined recording numbers for said second line and
when said density difference between the image densities of said successive two lines exceeds said predetermined value and said first line to be first recorded is lower in density than said second line to be subsequently recorded, said control unit sets recording times, recording amplitudes or recording numbers for said second line to be subsequently recorded to be longer, larger or more than said predetermined recording times, said predetermined recording amplitudes or said predetermined recording numbers for said second line, respectively.
